(19) United States
(12) Patent Application Publication
(10) Pub. No.: US 2013/0207545 A1
(43) Pub. Date: Aug. 15, 2013

(54) Device for the Controlled Generation of Electric Arcs

(71) Applicants: Jonathan Andrea, Golbey (FR); Patrick Schweitzer, Heillecourt (FR)

(72) Inventors: Jonathan Andrea, Golbey (FR); Patrick Schweitzer, Heillecourt (FR)

(73) Assignee: UNIVERSITE DE LORRAINE, Nancy Cedex (FR)

(21) Appl. No.: 13/806,698

(22) PCT Filed: Jun. 22, 2011
(86) PCT No.: PCT/EP2011/060525

§ 371 Date: Jan. 17, 2013

(30) Foreign Application Priority Data
Jun. 25, 2010 (FR) 1055074

(51) Int. Cl. H01T 15/00

(52) U.S. Cl. CPC H01T 15/00
USPC 315/112

(57) ABSTRACT

A device for the controlled generation of an electric arc comprises at least: a system for striking an electric arc on the terminals of two electrodes through inductive switching, producing at the output an overvoltage on the terminals of these electrodes; and a power source connected in series to the output of the striking system and loaded by an electric load, said power source supplying the electric arc with current. The device is applied notably to carry out reliable tests on electric arc detectors.

The present invention relates to a device for the controlled generation of electric arcs. The invention is applied notably to carry out reliable tests on electric arc detectors.

The faults of electric arcs in electrical installations, notably when they are repeated, can cause significant damage and even start fires. In certain domains, the generation of arcs is particularly critical, notably in on-board systems. This is the case in the aeronautical domain, which requires very great vigilance, from power generation systems to control equipment. It is therefore important to be able to detect electric arcs in sensitive electrical installations or systems, and even in most electrical systems, including domestic systems. Reliable electric arc detectors are required for this purpose.

A device which protects against electric arcs must be capable of detecting the presence of an arc and must be capable of estimating its level of danger in comparison with known safety curves stored elsewhere. Functional tests of the detectors used must notably:
allow four types of electric arc to be produced;
generate a reproducible calibrated arc;
be capable of adjusting the amplitude and persistence of the arcs;
allow different open-circuit faults to be tested.

As far as the four types of generated electric arcs are concerned, a standard electrical installation is generally considered in which a main electrical generator supplies a load. The different electric arcs resulting from a fault can be classified into four categories combining, on the one hand, alternating voltage or direct voltage electrical generators and, on the other hand, the configurations of arcs in series or in parallel with the load.

Methods exist for generating electric arcs to test the electric arc detectors with the aim notably of testing their reliability, in particular:
the guillotine test;
the contact loss test;

In the guillotine test, an arc is struck by the direct disconnection of two cables supplying the load, one carrying the current of the generator to the load and the other from the load to the generator. A short circuit is then generated on the terminals of the load, producing a parallel electric arc. In the contact loss test, the intermittent circuit openings are caused by vibrations and the contact losses can occur in the connectors. Arcs in series are produced in series with the opening of the circuit.

Other tests also exist. However, all these known tests do not allow calibrated and reproducible arcs to be produced, i.e. conditions for testing arc detectors in a reliable manner.

One object of the invention is notably to overcome this disadvantage. For this purpose, the subject-matter of the invention is a device for the controlled generation of an electric arc, comprising at least:
a system for striking an electric arc on the terminals of two electrodes through inductive switching, producing at its output an overvoltage on the terminals of these electrodes;
an electrical power source connected in series to the output of the striking system, said source supplying the electric arc with current.

This electrical power source is formed by a voltage generator or a current generator for which an electric load defines the value of the current.

The striking system comprises, for example, at least one transformer, a primary voltage generator and a switch connected in series with the primary coil of said transformer, the overvoltage on the terminals of the electrodes being generated on the terminals of the secondary coil of the transformer when the switch is in the closed position, the duration of closure of the switch being controllable.

In one possible embodiment, the electric load is connected in series with the voltage generator.

In a different possible embodiment, the electric load is connected in parallel with the voltage generator.

The value of the electric load is, for example, controllable.

The voltage at the voltage generator output may be direct or alternating.

The electrodes are, for example, placed in a container in which environmental conditions are stimulated.

The container comprises, for example, a controllable heating and cooling system.

The device comprises, for example, a controllable vacuum pump connected to the container to control the pressure inside said container.

It comprises, for example, a system to move the electrodes towards or away from one another, said system being controllable.

Other characteristics and advantages of the invention will become evident from the description which follows, given with reference to the attached drawings, in which:

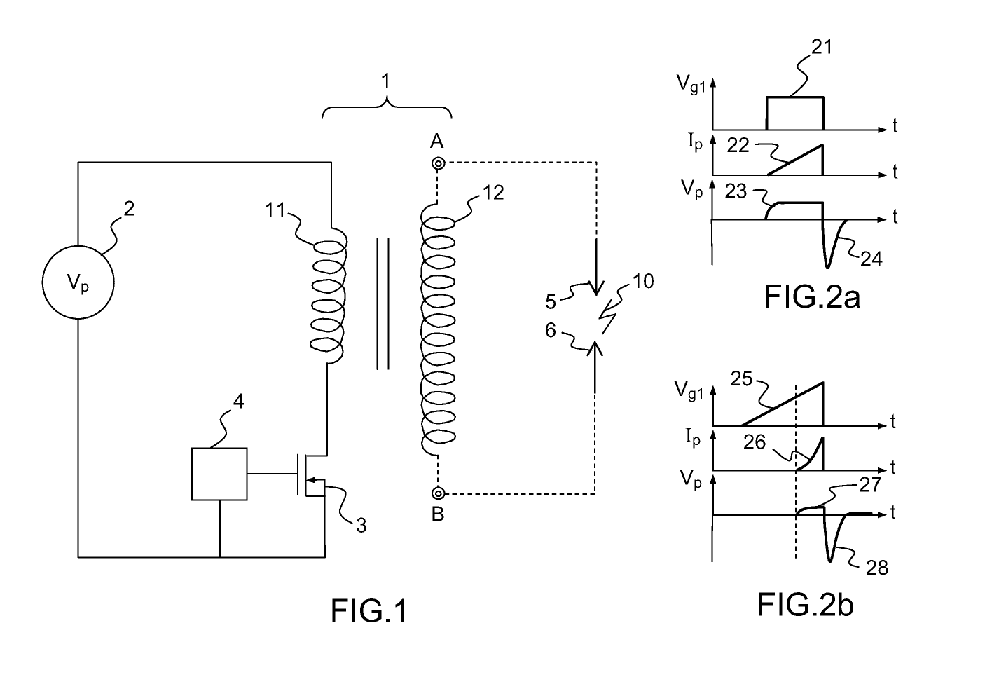

FIG. 1 shows an example embodiment of a striking system used in a device according to the invention;

FIGS. 2a and 2b show switching examples;

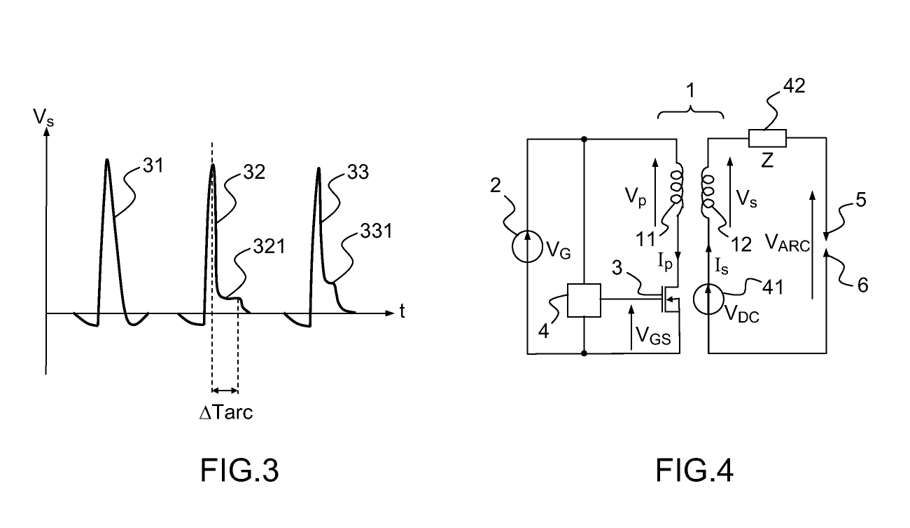

FIG. 3 shows examples of overvoltages produced on the secondary of a transformer in the presence of an electric arc;

FIG. 4 shows an example embodiment of a device according to the invention;

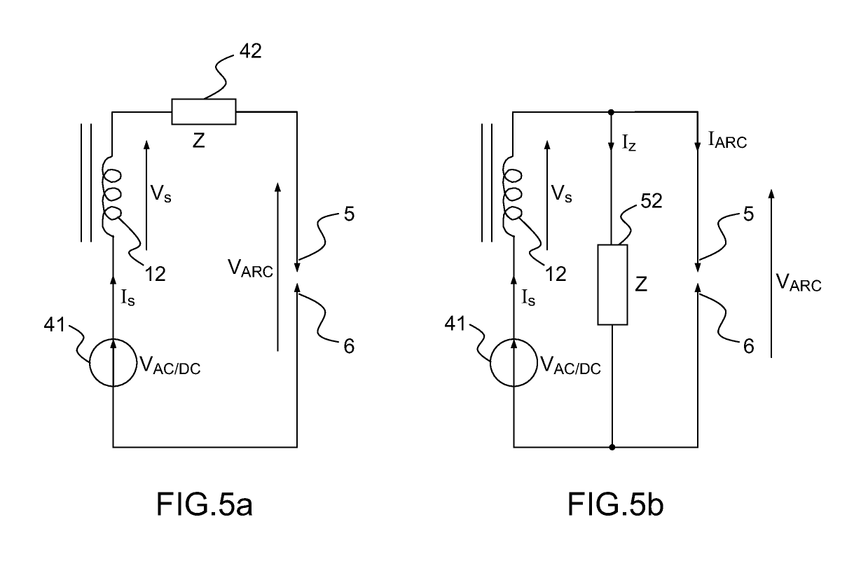

FIGS. 5a and 5b show configuration examples of electric arc generation, in series or in parallel on a load, in direct or alternating mode;

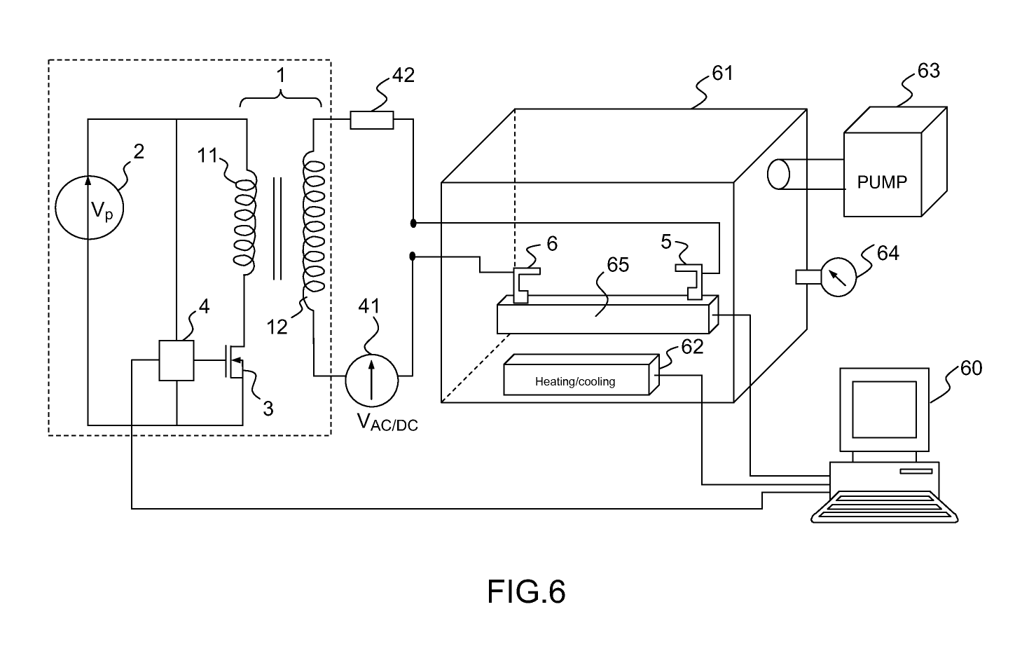

FIG. 6 shows an example embodiment of a device according to the invention, notably allowing environmental conditions to be simulated.

FIGS. 1 and 4 and FIGS. 5a, 5b and 6 show a plurality of possible embodiments of a device according to the invention.

More particularly, FIG. 1 shows the part of the device which instigates the striking of an arc. In the device example shown in FIG. 1, the striking is obtained through inductive switching producing an overvoltage. In the case of the example shown in FIG. 1, the switched inductance is the primary coil of a transformer 1, the overvoltage being produced at the output of the secondary coil of the transformer, the transformer allowing the overvoltage produced on the primary coil to be amplified.

The device comprises notably a voltage step-up transformer 1 comprising a primary winding 11 and at least one secondary winding 12, a primary voltage generator 2, a switch 3 and a system 4 for controlling this switch. The primary winding 11 is, on the one hand, connected at one terminal to the voltage generator 2 and is connected at the other terminal to the switch 3. In other words, this primary winding is connected to the terminals of the generator 2 via a switch 3, the voltage on the terminals of this winding being equal to the voltage of the generator when the switch is in the closed state The switch 3 is, for example, a MOS transistor.

The principal of striking the electric arc on the secondary of the transformer 1 is based on the initialization of an overvoltage. Firstly, the primary coil 11 of the transformer is loaded by the current supplied by the primary voltage generator 2. The transistor 3 progressively carries the current flowing into the primary coil 11 until its maximum acceptable current value is reached. The transistor acting as a switch then quickly opens the circuit causing the current to change from the maximum value to a zero-value current. This quick opening causes the appearance of a high voltage Vₚ on the terminals of the primary coil 11 conventionally defined by the relation Vₚ=Lp dlₚ/dt, where Lp is the inductance of the primary coil, dlₚ is the current variation in this coil, between the maximum value and the zero value, and dt is the switching duration from one value to the other. This high voltage is all the greater when the inductance Lp is high and the switching time dt is short. If the transformer is a step-up transformer as in the example shown in FIG. 1, the high voltage produced on the terminals of the primary coil is amplified on the terminals of the secondary coil. The transformation ratio between the secondary winding and the primary winding is, for example, in the order of 100. The transistor 3 placed on the primary of the transformer is, for example, dimensions to carry a current which may reach 20 A, the primary generator 2 delivering, for example, a direct nominal voltage of 65 V and a nominal current of 50 A.

In the illustration method used in FIG. 1, the circuit on the secondary of the transformer 1, more particularly between the terminals A, B of the secondary coil 12, is shown in a simplified manner. Only the electrodes present 5, 6 likely to cause an electric arc are shown. The different embodiments of the secondary circuit of a device according to the invention are notably shown in FIG. 4 and FIGS. 5a and 5b.

An arc 10 appears between the electrodes 5, 6, when the ambient dielectric breakdown voltage between these electrodes is reached. This voltage is in the order of 30 kV/cm in the air. The breakdown voltage depends mainly on the distance separating the two electrodes 5, 6 and the rigidity of the dielectric. When the electrodes are in the air, the atmospheric conditions such as the temperature, pressure or hygrometry are also influencing factors. The same applies to the geometry and the material making up the electrodes.

FIGS. 2a and 2b show two possible methods for controlling the transistor 3 switching the current in the primary coil 11. The control is applied by the control system 4, the implementation of which is known to the person skilled in the art. FIGS. 2a and 2b show the methods of control by the voltage applied between the gate and the source of the transistor 3 as a function of time.

In the first method shown in FIG. 2a, Ie transistor is controlled by a gate-source voltage V_{gs} with a square-shaped appearance 21. The transistor acts as a switch. When it is in the closed state, the current Iₚ in the primary coil 11 increases in a linear manner up to the maximum value, then falls abruptly to the zero value, thus changing according to a ramp 22. During the loading of the primary coil 11, i.e. during the ramp 22, the voltage on the terminals of the primary coil vₚ quickly stabilizes to the voltage value Vₚ produced on the terminals of the generator. The switching then causes an inverse overvoltage spike 24, still on the terminals of the primary coil 11.

In the second method, shown in FIG. 2b, the overall energy expended is reduced. In this method, the gate-source control voltage V_{gs} is no longer square-shaped but has the shape of a ramp 25. The current in the primary coil begins to flow later to increase 26 to the maximum value. The voltage on the terminals of the primary winding remains low 27 during the loading of the coil. Finally, the inverse voltage spike 28 dependent on the maximum current value attained is the same as that obtained in the first method. The overall electrical power expended is distinctly lower than in the first method, as indicated by the comparison of the products of the voltage and current surfaces between FIGS. 2a and 2b.

FIG. 3 shows three possible cases of overvoltages on the terminals of the secondary coil 12, the curves showing the appearance of the voltage Vs on the terminals of the secondary coil as a function of time. The secondary coil is, for example, wired in such a way as to be inverted in relation to the primary voltage.

A first curve 31 corresponds to a case without arc production.

A second curve 32 shows a case with an arc. As in the preceding case 31, an overvoltage is produced when the breakdown voltage is reached, then the voltage falls and stabilizes at a given value 321 for the duration of the electric arc (Δ Tarc), this stabilized voltage characterizing the intensity of the electric arc. Finally, the arc disappears and the voltage falls to zero. A third curve 33 still shows a case with arc production, but where the distance between the electrodes has increased in such a way that the duration of the electric arc has reduced, the stabilized value 331 of the secondary voltage being shorter than the preceding value 321.

In the electric arc generation devices of the prior art, the intensity and duration of the arc are not controllable, i.e. in particular the intensity and duration cannot be calibrated in a repetitive manner.

FIG. 4 shows an example embodiment of a device according to the invention. The primary part of the device, the function of which is notably to strike the electric arc, is the same as shown in FIG. 1. A generator 2 supplies a voltage V_{G} to the primary coil which is loaded with a current Iₚ controlled by the switch 3, a MOS transistor in this example. As previously shown, the interruption of the primary current Iₚ causes an overvoltage on the terminals of the secondary coil 12 striking an arc as shown by the curves 32, 33 in FIG. 3.

The secondary coil 12 is connected in series to a load 42, itself in series with the electrodes 5, 6 on the terminals of which an electric arc is likely to be reproduced. In FIG. 4, the electrodes 5, 6 symbolize an electrical fault likely to occur, for example a cable disconnection or a contact loss, these faults being produced in the test phase. The load 42 in series represents an example of an application in which the fault occurs in series on an electric load, itself in series with the generator, as in the case notably of a fault through contact loss, for example in a connector.

The striking of the arc is followed by a voltage drop which stabilizes at a given value as shown by the curves 32 and 33 in FIG. 3. According to the invention, a source of electrical power, for example of current, is placed in series with the secondary coil 12 and the location of the circuit where the electric arc is produced, i.e. the electrodes 5, 6 in FIG. 4.

In the example shown in FIG. 4, the current source is formed on the basis of a voltage generator 41, the voltage being, for example, direct. The current is defined by the voltage on the terminals of the generator and the electric loads connected in series with the latter.

Advantageously, this generator 41 allows a current to be held in the electric arc, therefore allowing the latter to be maintained. By adjusting notably the intensity of the current and its duration, the intensity and the duration of the arc can be calibrated and the arc can furthermore be given a repetitive character. In practice, it is possible to adjust the output voltage of the generator which itself defines the intensity of the current as a function of the load. The example in FIG. 4 shows a case of an electric arc in an electrical system supplied by a direct voltage, the arc being produced in series with the electric load. Other types of generator can be used as shown in FIGS. 5a and 5b.

FIGS. 5a and 5b show four types of possible circuits on the secondary of a device according to the invention. These different wirings allow the following four cases to be tested:
system supplied by a direct voltage with an arc in series on the electric load;
system supplied by an alternating voltage with an arc in series on the electric load;
system supplied by a direct voltage with an arc in parallel on the electric load;
system supplied by an alternating voltage with an arc in parallel on the electric load;

The wiring shown in FIG. 5a allows the first two cases to be tested, the generator 41 being either direct voltage or alternating voltage and the load 42 being in series with the electric arc which is produced in the electrodes 5, 6. The wiring shown in FIG. 5b allows the last two cases to be tested, the generator 41 being either direct voltage or alternating voltage, and the load 52 being in parallel with the electric arc.

An operating principle of a device according the invention is therefore as follows. The primary part of the transformer 1 strikes the electric arc and the secondary part maintains this electric arc in a controlled manner.

Thus, the generator 2 on the primary supplies a load current to the primary coil 11, this load current being interrupted by the switch 3. An overvoltage is then produced on the terminals of the coil 12 of the transformer. The winding of the secondary coil is calculated to amplify the primary voltage in order to attain notably the required breakdown voltage.

On the secondary, once the switch is in the open position, the generator 41 takes over to maintain the arc. The value of the voltage and its duration allow the arc to be controlled at the required intensity and duration.

FIG. 6 shows an example embodiment of a generator of electric arcs according to the invention, allowing the environmental conditions of the electric arc to be parameterized.

In this example, the electric load 42 is in series with the electrodes 5, 6 on the terminals of which the electric arc is produced. A direct or alternating voltage generator 41 is connected in series with the load and the electrodes 5, 6 as in the example shown in FIG. 5a.

The electrodes 5, 6 are placed in a container 61 inside which environmental conditions can be parameterized. In this example, it is possible to reproduce temperature conditions and pressure conditions. It would be possible to envisage reproducing hygrometric conditions also, for example.

A heating and cooling device 62 placed inside the container 61 allows a given temperature to be set inside this container. The latter is furthermore connected via a pipe 66 to a vacuum pump 63 allowing a given pressure to be set inside, and a barometer 64 allows the internal pressure to be checked. The temperature range is, for example, between −10° et 50° Celsius while the pressure range is, for example, between 0.2 bar et 1 bar, whereby other ranges can of course be applied.

In addition to the parameterization of the environmental conditions, the device shown in FIG. 6 allows the distance between the electrodes 5, 6 to be parameterized. For this purpose, the electrodes 5, 6 are mounted on a system 65 which controls their movement, for example an endless screw system which causes the movement of a plate. The movement is then controlled by the rotation of the screw, itself controlled by a suitable device. This system 65 allows the electrodes 5, 6 to be moved towards or away from one another.

The adjustment of the arc installation time is, for example, effected automatically via the control circuit 4 providing the opening or closing of the switch 3 on the primary of the transformer 1. When the switch 3 is in the closed position, the secondary of the transformer acts as an overvoltage generator and strikes an electric arc between the electrodes 5, 6. When the switch 3 is open, the generator in the secondary no longer supplies the load, this supply being taken over by the voltage generator 41 which similarly maintains the electric arc. The intensity of the current in the secondary circuit, and therefore in the electric arc, depends on the value of the load 42 mounted in series. The current can therefore be regulated by adjusting this load value. For this purpose, it is possible to provide a variable and controllable load, more particularly the value of the load resistance being controllable. The complex part of the load, the inductive and capacitive component, can also be controlled.

The different parameterizations of the circuit, in particular the intensity of the current in the electric arc, the striking duration of this electric arc, the temperature and pressure conditions are, for example controllable from a computer 60 connected via suitable interface means to the control units of the load 42, of the switch 3, of the heating and cooling system 62 and of the pump 63. A plurality of control programs can therefore be implemented automatically by the computer 60.

A device according to the invention allows arcs to be produced in a controlled manner in terms of intensity and duration, in series and in parallel, in direct or alternating mode. According to the chosen configuration, the arc fault can be created systematically for each overvoltage and the secondary generator 41 supplies the power which allows the electric arc to be maintained, in series or in parallel with a load. Different types of load, including specific circuit breakers, can be used in order to observe the behavior of the arc fault in a complex circuit.

The invention advantageously allows all types of arc-disconnecting equipment and systems to be tested.

1. A device for the controlled generation of an electric arc, comprising:
a system for striking an electric arc on the terminals of two electrodes through inductive switching, producing at its output an overvoltage on the terminals of these electrodes; and
an electrical power source connected in series to the output of the striking system, said source supplying the electric arc with current.

2. The device as claimed in claim 1, wherein the electrical power source is a voltage generator, an electric load defining the value of the current.

3. The device as claimed in claim 1, wherein the electrical power source is a current generator, an electric load defining the value of the current.

4. The device as claimed in claim 1, wherein the striking system comprises at least a transformer, a primary voltage generator and a switch connected in series with the primary coil of said transformer, the overvoltage on the terminals of the electrodes being generated on the terminals of the secondary coil of the transformer when the switch is in the closed position.

5. The device as claimed in claim 4, wherein the duration of closure of the switch is controllable.

6. The device as claimed in claim 1, wherein the electric load is connected in series with the electrical power source.

7. The device as claimed in claim 1, wherein the electric load is connected in parallel with the electrical power source.

8. The device as claimed in claim 6, wherein the value of the electric load is controllable.

9. The device as claimed in claim 2, wherein the voltage at the output of the voltage generator is direct.

10. The device as claimed in claim 2, wherein the voltage at the output of the voltage generator is alternating.

11. The device as claimed in claim 1, wherein the electrodes are placed in a container in which environmental conditions are simulated.

12. The device as claimed in claim 11, wherein the container comprises a controllable heating and cooling system.

13. The device as claimed in claim 11, further comprising a controllable vacuum pump connected to the container to control the pressure inside said container.

14. The device as claimed in claim 1, further comprising a system to move the electrodes away from or towards one another, said system being controllable.
